(19) United States
(12) Patent Application Publication
(10) Pub. No.: US 2002/0040334 A1
(43) Pub. Date: Apr. 4, 2002

(54) Method of and apparatus for setting support fee, and computer product

(75) Inventor: Takanori Yamazaki, Tokyo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/865,706

(22) Filed: May 29, 2001

(30) Foreign Application Priority Data
Sep. 29, 2000 (JP) 2000-301275

(51) Int. Cl. G06F 17/60

(52) U.S. Cl. 705/34

(57) ABSTRACT

In the support fee setting apparatus, user's name and a grade for service are stored in a one-to-one correspondence. Points derived from a responding activity to an inquiry from a user are converted to an amount according to the grade of the user by using a point conversion table. An amount is set for each grade, and the support fee is computed as a total of the amounts and the actual cost for the responding activity to the inquiry from the user.

### FIELD OF THE INVENTION

The present invention relates to a technology for giving a support to computer users such as on how to use computer hardware, software, and system resources.

### BACKGROUND OF THE INVENTION

Conventionally, computer vendors have been providing extra-cost service for their computer users, especially, user companies. The support includes diversified contents, such as software inquiry service, software install service, hardware on-site repair service, hardware maintenance and routine service, and hardware failure monitor service, and each computer vendor presents their unique support contents menus.

A common contents menu is generally presented to the all users, and the user selects service he would like to obtain. Hence, a fee for the support of the same nature is equal among all the users under the contract.

Some users make a contract for each product, and also in this case, the contract is often made on a predetermined fee system depending on the support contents.

Thus, the usage pattern of the support provided from the vendor varies at each user's end.

In terms of technical levels, the usage pattern varies from a fundamental inquiry from a user's lack of understanding of technology to a critical and highly difficult problem related to the basic operation of a computer system.

Also, in terms of usage frequencies of the support service, some users seldom use the service while some users use the service frequently.

Hence, the usage pattern of the support service varies with each user and there is a considerable difference in the contents of the support service among the users. However, all the users make a contract for the support service on the same fee. Thus, an adequate fee system according to the support contents has not been achieved yet.

Further, even when a user makes a contract for each product, if the support of the same nature is required for more than one product, the support, which is legitimately an extra-cost option, is provided substantially free for the other products in most of the cases, or the user obtains only insufficient support as the vendor stops the inspection, which causes an inconvenience at both the vender's end and user's end.

### SUMMARY OF THE INVENTION

It is an object of this invention to provide method of and apparatus for setting a support fee (i.e. fee charged for giving support), in which more fee is charged to users who frequently use support service, and less fee is charged to users who use the support service less frequently by grading users and using the grades as an indicator. It is another object of this invention to provide a computer readable recording medium that stores a computer program which when executed realizes the method according to the present invention.

According to the method and apparatus of this invention, user's name and a grade for a service are stored in a one-to-one correspondence, points derived from a job responding to an inquiry from a user are obtained from a job-to-point conversion table, the grade of the user is obtained by referring to a user information database that has stored the user name and the grade for service for the user, and support fee is set based on the grade of the user, the points derived, and an actual cost for a responding activity to the inquiry from the user.

Thus, the fees are charged according to the usage pattern. Users who use the service less frequently can make a support contract at a lower fee. In addition, because the grade-based system is employed, a veteran user using the service less frequently can obtain the support at a lower fee compared with the conventional usage-based system.

Other objects and features of this invention will become apparent from the following description with reference to the accompanying drawings.

### BRIEF DESCRIPTION OF THE DRAWINGS

FIG. 1 is a view depicting an arrangement of a system in accordance with one embodiment of the present invention;

FIG. 2 is a view showing an example of a user information database;

FIG. 3 is a view showing an example of a history information database;

FIG. 4 is a flowchart detailing a procedure when registering or updating user information;

FIG. 5 is a flowchart detailing a procedure when registering history;

FIG. 6 is an example of a job-to-point conversion table;

FIG. 7 is a flowchart detailing a procedure when creating a statement;

FIG. 8 is an example of a point conversion table;

FIG. 9 is an example of a statement;

FIG. 10 is a flowchart detailing a procedure when evaluating the grade for each user; and

FIG. 11 is a view showing a grade conversion table.

### DESCRIPTION OF THE PREFERRED EMBODIMENTS

Preferred embodiments of the method, apparatus and computer readable-recording medium according to this invention will be explained in detail below with reference to the accompanying drawings.

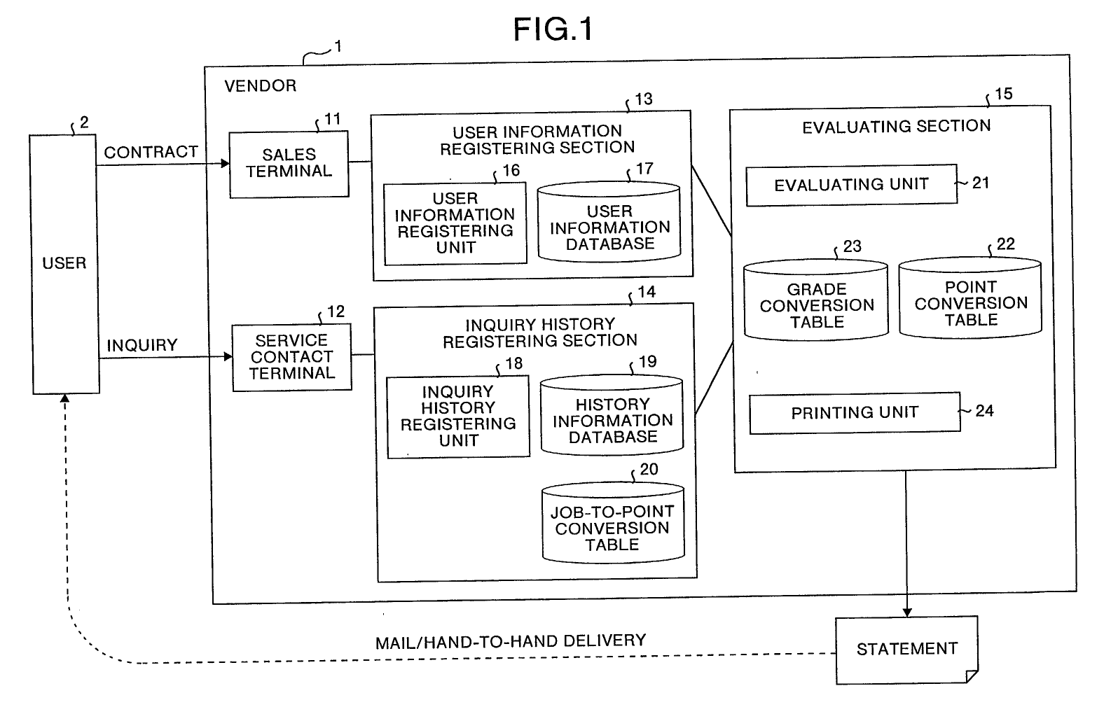

FIG. 1 is a view depicting an arrangement of a system used in one embodiment of the present invention. Reference numeral 1 denotes a vendor and reference numeral 2 denotes a user.

The vendor 1 includes sales terminal 11, service contact terminal 12, user information registering section 13, inquiry history registering section 14, and evaluating section 15. The user information registering section 13 includes user information registering unit 16 and user information database 17. The inquiry history registering section 14 includes inquiry history registering unit 18, history database 19, and job-to-point conversion table 20. The evaluating section 15 includes evaluating unit 21, point conversion table 22, grade conversion table 23, and printing unit 24.

Once the user 2 makes a service contract with the vendor 1, the user information is sent to the user information registering section 13 through the sales terminal 11 of the vendor 1, whereupon the information is registered in the user information database 17 by the user information registering unit 16.

The user 2 makes an inquiry to the vendor 1 through the service contact terminal 12, and the content of the inquiry is sent to the inquiry history registering section 14, whereupon the inquiry information is registered in the inquiry history database 19 by the inquiry history registering unit 18.

The job-to-point conversion table 20 of the history registering section 14 stores a job and points in a one-to-one correspondence. The history database 19 registers the user information together with an amount (actual cost) and points for a job done for each user.

The evaluating section 15 sets a usage fee and evaluates the grade for each user based on the user information database 17 and inquiry history database 19 by using the evaluating unit 21, and prints out the result as a statement for each user by using the printing unit 23.

The printed statement is dispatched by mail or directly delivered to the user 2.

The point conversion table 22 of the evaluating section 15 stores a fee per point for each grade. Here, the higher is the grade, the lower is the changed fee. The grade conversion table 23 of the evaluating section 15 stores the service costs and corresponding grades. Here, the higher the cost, the lower the grade becomes.

The sales terminal 11 and service contact terminal 12 are provided separately in the vendor 1 by giving consideration to a case where the user 2 makes a contract and an inquiry with the vendor 1 at different sections or persons (the sales department and the inquiry contact department). Hence, the above two terminals may be synthesized into a single terminal, or more than two terminals may be provided depending on the system at the vendor's end.

Also, once the user 2 makes the support contract at the sales department of the vendor 1, the user 2 can make an inquiry to the contact department via a telephone, an e-mail, facsimile transmission, etc.

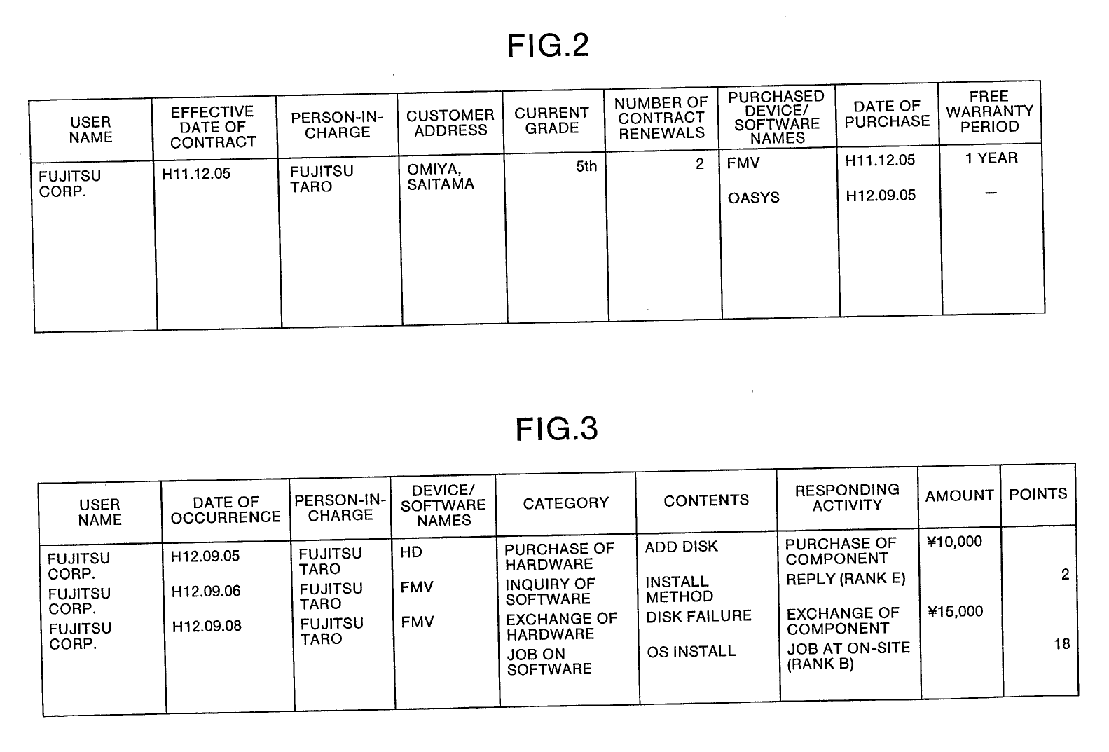

FIG. 2 is a view showing an example of a data structure of the user information registered in the user information database 17 of the user information registering section 13. As is shown in the drawing, the user name, effective date of the contract, person-in-charge, user address, current grade, number of contract renewals, purchased device and software names, date of purchase, and free warranty period are stored for each user.

“Person-in-charge” means a person at the user's end who made the contract and an inquiry. In addition, the grades can be set arbitrarily, and in the present embodiment, the users are graded on a scale of 1 to 10 from highest to lowest.

FIG. 3 is a view showing an example of the history information database for an inquiry from the user registered in the history information database 19 of the inquiry history registering section 14. The user name, date of inquiry, person-in-charge, device and software names, category of an inquiry, content of an inquiry, responding activity to an inquiry, actual cost for responding to the inquiry, and points for an inquiry are stored for each user.

The points are the base on which the grade is set, and determined in accordance with a response to the content of the inquiry. If the response involves an activity of higher technique, higher points are set. The user is graded based on a total of the points, namely, accumulated points. Hence, the points are accumulated more with an increasing number of inquiries, which lowers the grade of the user as a consequence.

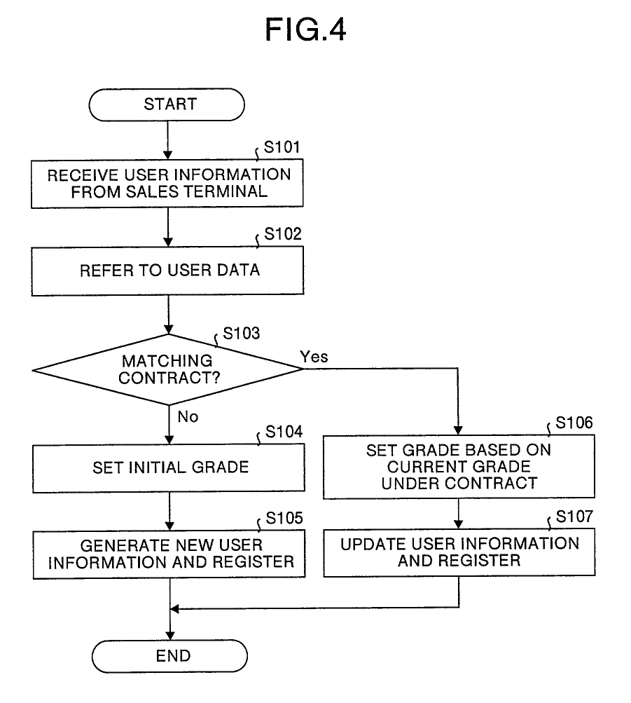

How the user information registering unit 16 registeres or updates the user information will be explained with reference to the flowchart of FIG. 4.

Initially, information of the user having made the contract is sent from the sales terminal 11 in Step S101.

Then, in Step S102, the user information registering unit 16 refers to user information registered in the user information database 17.

In Step S103, the user information registering unit 16 judges whether the user information includes the contract of the user in question. Upon judgment of no matching contract, the user information registering unit 16 proceeds to Step S104.

The user information registering unit 16 sets an initial grade in Step S104. By giving consideration to a possible shifting (upgrade/downgrade) of the grade, a middle grade is set as the initial grade. As has been discussed, ten grades are set in total in the present embodiment, and the initial grade is set at the fifth grade in the middle.

Then, in Step S105, the user information registering unit 16 generates registration data based on the receipt user information and the newly set grade, and registers the same as new user information in the user information database 17.

Upon judgment of the matching contract in Step S103, the user information registering unit 16 proceeds to Step S106, wherein the user information registering unit 16 refers to the grade set based on the content of the existing contract and sets the same.

In Step S107, the user information registering unit 16 updates the user information database 20 with the new user information and registers the same. Here, the grade set for the existing contract is used intact.

How the inquiry history registering unit 18 registers the history will be explained with reference to the flowchart of FIG. 5.

Initially, the actual cost for a job responding to the content of an inquiry from the user is computed in Step S201. Actual expenses incurred may be inputted directly as the actual cost through an input terminal. Alternatively, an amount conversion table based on the standard number of steps may be prepared, so that an amount corresponding to the number of steps is inputted automatically upon input of the content of the job through the input terminal.

Then, in Step S202, points for the job (including a reply) responding to an inquiry from the user are obtained from the job-to-point conversion table 20.

In case of a job with no actual cost or points, only the points or actual cost is computed.

There is no actual cost during the free warranty period. In this case, points may be generated or not generated at all, or generated at a 50% discount.

In Step S203, the inquiry history registering unit 18 registers the user name, date of inquiry, person-in-charge, device and software names, category, content, responding activity, amount, and points for each user in the inquiry history database 19.

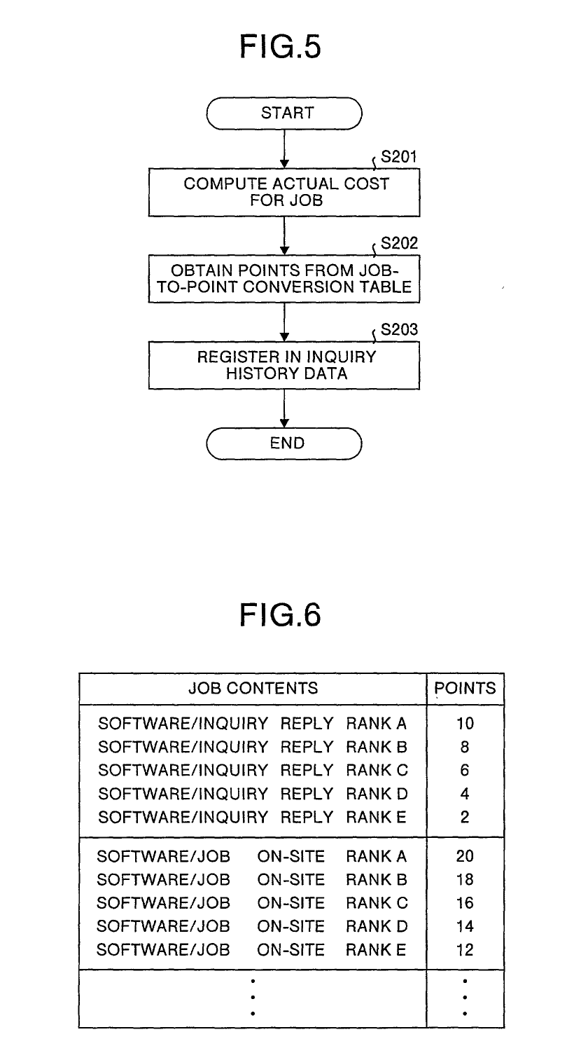

FIG. 6 is a view showing an example of a data structure in the job-to-point conversion table 20, which stores points and a job content in a one-to-one correspondence.

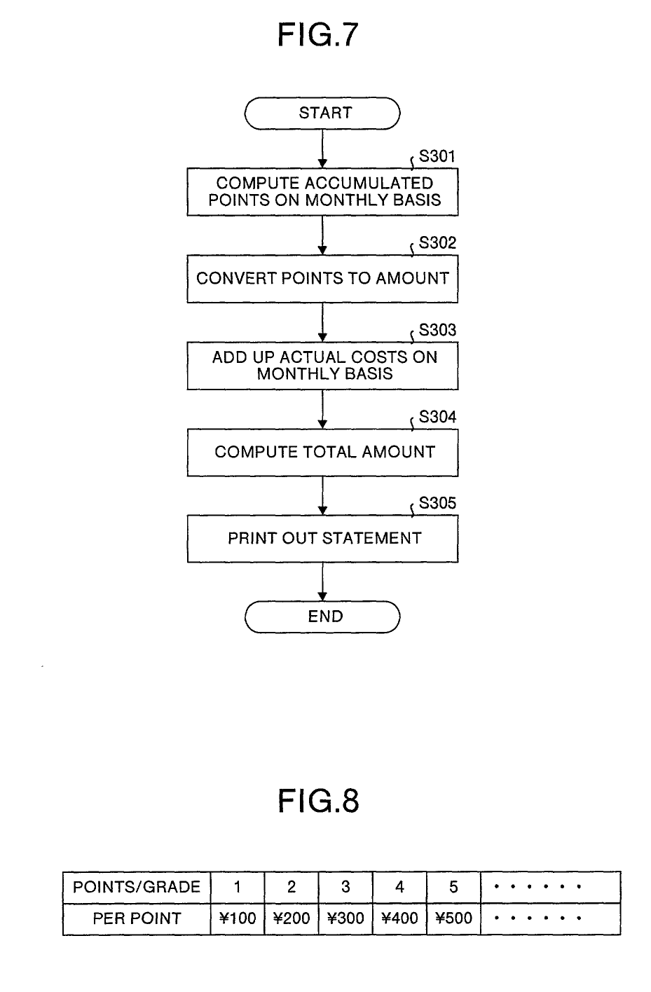

How the evaluating unit 21 creates a statement will be explained with reference to FIG. 7.

Initially, in Step S301, the evaluating unit 21 refers to the points for each user in the history information database 19, and computes accumulated points on a monthly basis.

Next, in Step S302, the evaluating unit 21 converts the accumulated points to an amount from the point conversion table 22. This conversion is based on the grade, and the points are converted to a lower amount as the grade becomes higher, and to a higher amount as the grade becomes lower.

In Step S303, the evaluating unit 21 refers to the actual cost for each user in the history information database 19, and adds up the actual costs on a monthly basis.

Then, in Step S304, the evaluating unit 21 computes a sum of the amount converted from the accumulated points and a total of the actual costs.

In Step S305, the evaluating unit 21 refers to the history information database 19 and obtains the inquiry history on a monthly basis for each user, and prints out a statement together with the total amount, the total of the points, and the total amount of the bill by using the printing unit 24.

FIG. 8 is a view showing an example of the point conversion table 22. As is shown in the drawing, an amount per point is stored for each grade. Here, instead of setting an amount per point, amounts for corresponding points may be set directly in each grade. In this case, it may be arranged such that the amount remains the same for the points exceeding a certain level. This can prevent putting too much burden on the user.

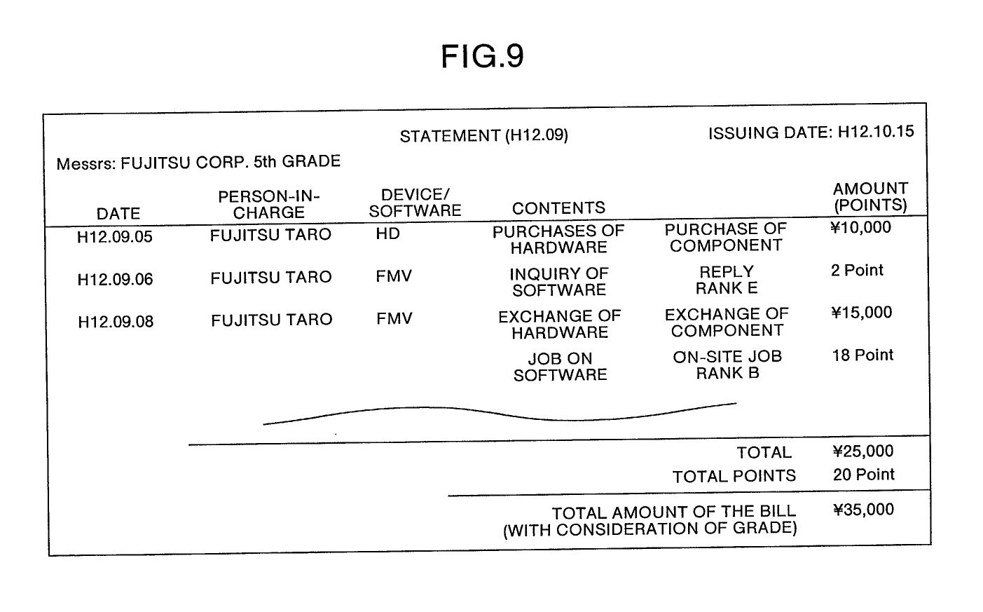

FIG. 9 is a view showing an example of the printed statement. The statement is issued monthly for each user, which includes the date of inquiry, person-in-charge, device and software names, job content, amount (points), and total amount, total of the points, and total amount of the bill with consideration given to the grade.

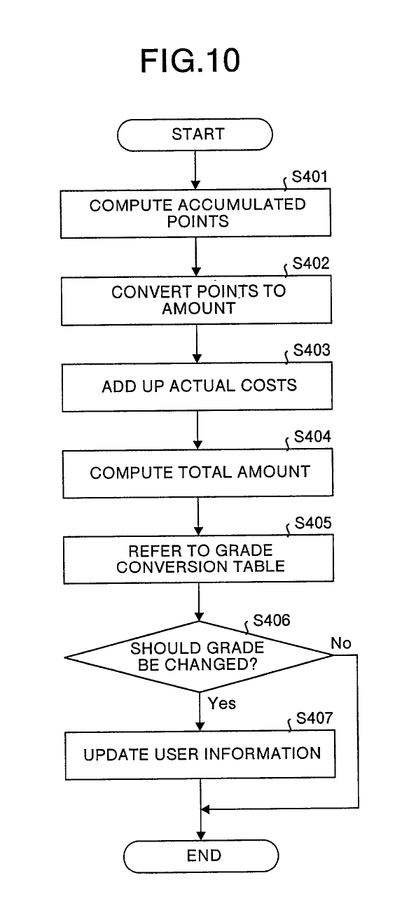

How the evaluating unit 21 evaluates the grade of each user will be explained below with reference to the flowchart of FIG. 10.

Initially, in Step S401, the evaluating unit 21 refers to the points for each user in the history information database 19, and computes accumulated points for a predetermined period. This computation is made by adding up the points for the predetermined period set under the contract. The period can be a year, six months, etc., or opted by the user from several alternative periods.

Then, in Step S402, the evaluating unit 21 converts the accumulated points to an amount from the point conversion table 22.

In Step S403, the evaluating unit 21 refers to the actual costs for each user in the history information database 19, and adds up the actual costs for the above described predetermined period.

Then, in Step S404, the evaluating unit 21 computes a total amount of the amount converted from the accumulated points and the total of the actual costs.

In Step S405, the evaluating unit 21 obtains the grade according to the total amount with reference to the grade conversion table 23. Different grade conversion tables are prepared for different predetermined periods, and an adequate one is selected based on the contents of the contract.

Then, in Step S406, the evaluating unit 21 judges whether there is any discrepancy between the new grade obtained and the current grade. Upon the judgment of no discrepancy, the evaluating unit 21 ends the flow. Upon the judgment of a discrepancy, the evaluating unit 21 proceeds to Step S407, and updates the grade in the user information database 17.

Instead of performing Steps S401 to S404, total amount for the predetermined period may be computed from the total amount of the bill computed for the monthly statement.

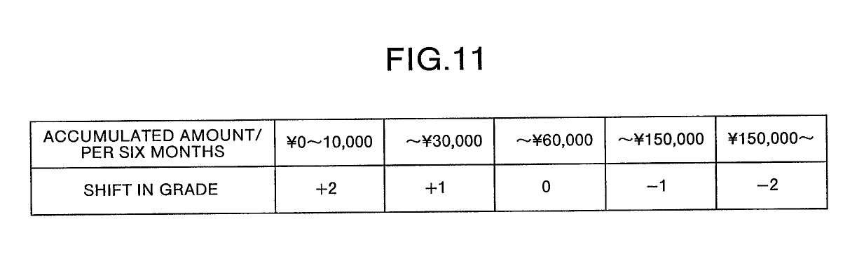

FIG. 11 is a view showing an example of the grade conversion table 23, which shows how the current grade is changed according to the total amount. Because the grade can be shifted neither above the first grade nor below the tenth grade, if the changed grade is beyond the scale, the grade is deemed as shifted to the first grade or tenth grade.

The grade conversion table 23 shown in the drawing is based on an aggregate of total amount every six months. Thus, it should be appreciated that the aggregate amount that causes the grade to shift varies with the period, such as one year or three months.

A computer program containing instructions which when executed on a computer causes the computer to perform the method according to the present invention is recorded on computer readable-recording medium. This computer readable-recording medium may be a floppy disk or a CD-ROM. Alternately the program may be stored at a server and the program may be downloaded when required. Otherwise, the program may be executed while it is at the server, i.e. without downloading from the server.

In the present embodiment, the user makes the contract and an inquiry with the person-in-charge at the vendor through a meeting, via a telephone, or the like, and the statement in written form is dispatched by mail or directly delivered to the user by a person-in-charge at the vendor. When the customer's Internet environments are fully accommodated and the security is ensured by the cryptosystem or the like, it should be appreciated that the user and vendor can communicate with each other through an e-mail or the Web over the Internet.

According to the present invention, the user only has to pay for the fees according to the usage pattern, and the users who use the service less frequently can make a support contract at a lower fee. In addition, because the grade-based system is employed, a veteran user using the service less frequently can obtain the support at a lower fee compared with the conventional usage-based system.

Consequently, incentives to obtain the higher grade are given to the user, which is expected to provide an effect of reducing unnecessary inquiries by using the service as an easy way.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A support fee setting method comprising the steps of:
storing a user name and a grade for service in a one-to-one correspondence;
obtaining points derived from a job responding to an inquiry from a user from a job-to-point conversion table;
obtaining the grade of the user by referring to a user information database that has stored the user name and the grade for service for the user; and
setting a support fee based on the grade of the user, the points derived, and an actual cost for a responding activity to the inquiry from the user.

2. The support fee setting method according to claim 1, wherein:
the points derived are converted to an amount according to the grade of the user by using a point conversion table, in which an amount is set for each grade; and
the support fee is computed as a total amount and a total of actual costs for the responding activity to the inquiry of the user.

3. The support fee setting method according to claim 1, wherein:
the points derived and the actual cost are stored in a history information database in correspondence with the user name; and
the points of the user and actual cost are obtained by referring to said history information database.

4. The support fee setting method according to claim 2, wherein:
the points derived and the actual cost are stored in a history information database in correspondence with the user name; and
the points of the user and actual cost are obtained by referring to said history information database.

5. The support fee setting method according to claim 1, wherein:
the total amount is a total of the amounts for a predetermined period;
a grade shifting value according to an aggregate of total amount is obtained by using a grade conversion table, in which an amount and a corresponding shift in grade are stored; and
the grade of the user in the user information database is updated based on the grade shifting value.

6. The support fee setting method according to claim 2, wherein:
the total amount is a total of the amounts for a predetermined period;
a grade shifting value according to an aggregate of total amount is obtained by using a grade conversion table, in which an amount and a corresponding shift in grade are stored; and
the grade of the user in the user information database is updated based on the grade shifting value.

7. The support fee setting method according to claim 3, wherein:
the total amount is a total of the amounts for a predetermined period;
a grade shifting value according to an aggregate of total amount is obtained by using a grade conversion table, in which an amount and a corresponding shift in grade are stored; and
the grade of the user in the user information database is updated based on the grade shifting value.

8. A support fee setting apparatus comprising:
a user information database which stores a user name and a grade for service in a one-to-one correspondence;
a history information database which stores actual cost and points derived from a responding activity to an inquiry from a user in correspondence with each user name; and
an evaluating section for setting a support fee based on the points derived and actual cost.

9. A computer readable medium storing instructions for causing a computer to perform the steps of:
storing a user name and a grade for service in a one-to-one correspondence;
obtaining points derived from a job responding to an inquiry from a user from a job-to-point conversion table;
obtaining the grade of the user by referring to a user information database that has stored the user name and the grade for service for the user; and
setting a support fee based on the grade of the user, the points derived, and an actual cost for a responding activity to the inquiry from the user.

10. A computer program for causing the computer to perform the steps of:
storing a user name and a grade for service in a one-to-one correspondence;
obtaining points derived from a job responding to an inquiry from a user from a job-to-point conversion table;
obtaining the grade of the user by referring to a user information database that has stored the user name and the grade for service for the user; and
setting a support fee based on the grade of the user, the points derived, and an actual cost for a responding activity to the inquiry from the user.
